(19) United States
(12) Patent Application Publication
(10) Pub. No.: US 2020/0073628 A1
(43) Pub. Date: Mar. 5, 2020

(54) CONTENT COLLABORATION

(71) Applicant: INTERNATIONAL BUSINESS MACHINES CORPORATION, Armonk, NY (US)

(72) Inventors: Wu Song Fang, Beijing (CN); Si Bin Fan, Beijing (CN); Ting Chen, Beijing (CN); Xing Xing Jing, Beijing (CN); Xiao Ying Zhou, TianJin (CN); Bin Xiong, Beijing (CN)

(21) Appl. No.: 16/116,200

(22) Filed: Aug. 29, 2018

(51) Int. Cl. G06F 3/16; G06F 3/14; G10L 17/22

(52) U.S. Cl. CPC G06F 3/167; G10L 17/22; G06F 3/1454

(57) ABSTRACT

A method, a device and a computer program product for content collaboration are proposed. One or more computer processors determine voice identification information of a first user based on a voice input from the first user. The one or more computer processors determine a focus for the first user based on the voice identification information, the focus for the first user associated with first content appearing on a screen of the first user. The one or more computer processors set a focus for a second user to be same as the focus for the first user, the focus for the second user associated with second content displayed on a screen of the second user.

### BACKGROUND

The present invention relates to information processing, and more specifically to content collaboration.

### SUMMARY

According to one embodiment of the present invention, there is provided a method for content collaboration. In the method, voice identification information of a first user is determined based on a voice input from the first user by a computing server. A focus for the first user is determined based on the voice identification information by a computing server. The focus for the first user is associated with first content displayed on a screen of the first user. A focus for a second user is set to be same as the focus for the first user by a computing server. The focus of the second user is associated with second content displayed on a screen of the second user.

According to another embodiment of the present invention, there is provided a device for content collaboration. The device comprises a processing unit and a memory coupled to the processing unit and storing instructions thereon. The instructions, when executed by the processing unit, performing acts including: determining voice identification information of a first user based on a voice input from the first user; determining a focus for the first user based on the voice identification information, the focus for the first user associated with first content displayed on a screen of the first user; and setting a focus for a second user to be same as the focus for the first user, the focus of the second user associated with second content displayed on a screen of the second user.

According to yet another embodiment of the present invention, there is provided a computer program product being tangibly stored on a non-transient machine-readable medium and comprising machine-executable instructions. The instructions, when executed on a device, causing the device to perform acts including: determining voice identification information of a first user based on a voice input from the first user; determining a focus for the first user based on the voice identification information, the focus for the first user associated with first content displayed on a screen of the first user; and setting a focus for a second user to be same as the focus for the first user, the focus of the second user associated with second content displayed on a screen of the second user.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a schematic diagram of a traditional interface displayed on a screen of a user.

FIG. 5A shows a schematic diagram of a traditional interface displayed on a screen of one user; and FIG. 5B shows a schematic diagram of another traditional interface displayed on a screen of another user.

FIG. 6 shows an example content collaboration environment according to an embodiment of the present invention.

FIG. 7 shows a flow chart of an example method for content collaboration according to an embodiment of the present invention.

FIG. 8 shows a flow chart of another example method for content collaboration according to an embodiment of the present invention.

FIG. 9 shows a schematic diagram of an example interface containing a cursor displayed on a screen of a user according to an embodiment of the present invention.

FIG. 10A shows a schematic diagram of an example interface displayed on a screen of one user according to an embodiment of the present invention; FIG. 10B shows a schematic diagram of another example interface displayed on a screen of another user according to an embodiment of the present invention; and FIG. 10C shows a schematic diagram of yet another example interface displayed on a screen of yet another user according to an embodiment of the present invention.

Throughout the drawings, same or similar reference numerals represent the same or similar element.

### DETAILED DESCRIPTION

Nowadays, various types of collaborative applications facilitate collaboration of a plurality of users in a variety of actions. For example, a Real Time Collaborative Editing (RTCE) software is a form of collaborative application that supports parallel editing by a plurality of users. The collaborative application allows the users to edit a computer file/document using different computers. When the computer file under editing is too long to be displayed entirely on the screen of the user, the edited computer file needs to be scrolled to focus on a specific part of the computer file. However, different users may focus on different parts of the computer file. In this case, inconsistency in the focus for the users occurs, and thus degrading the collaboration of the users.

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein.

As used herein, the term “includes” and its variants are to be read as open ended terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

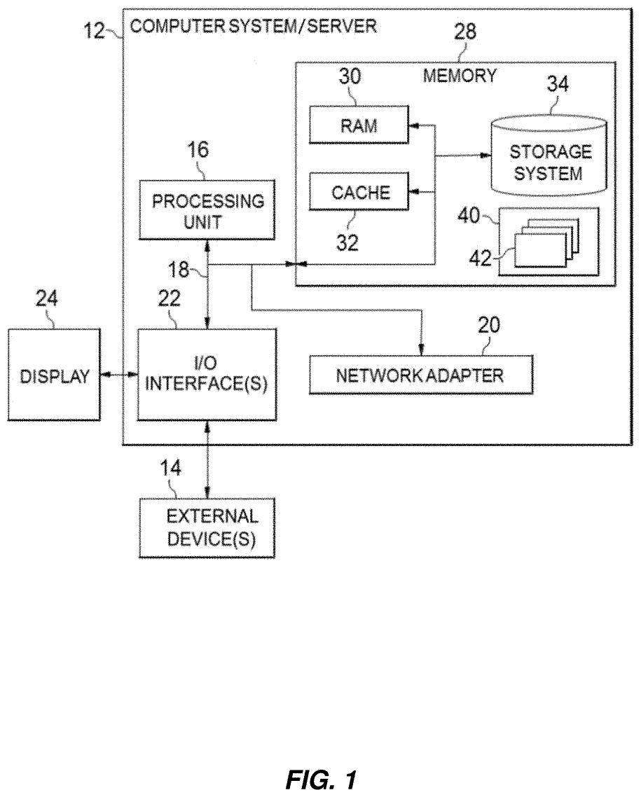

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

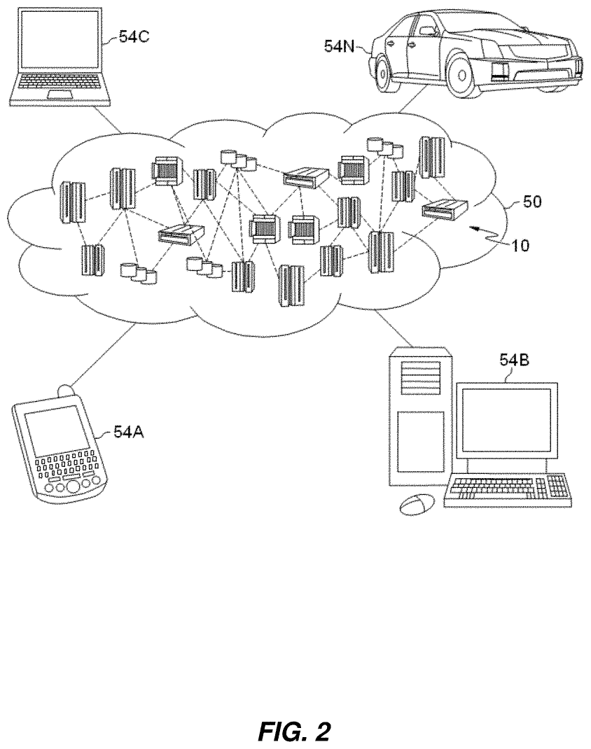

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

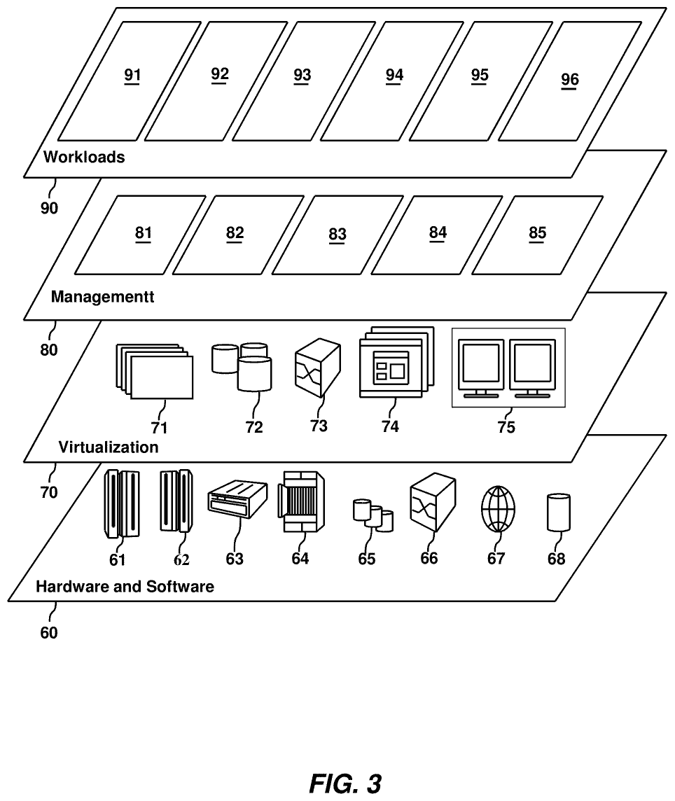

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and content collaborating 96.

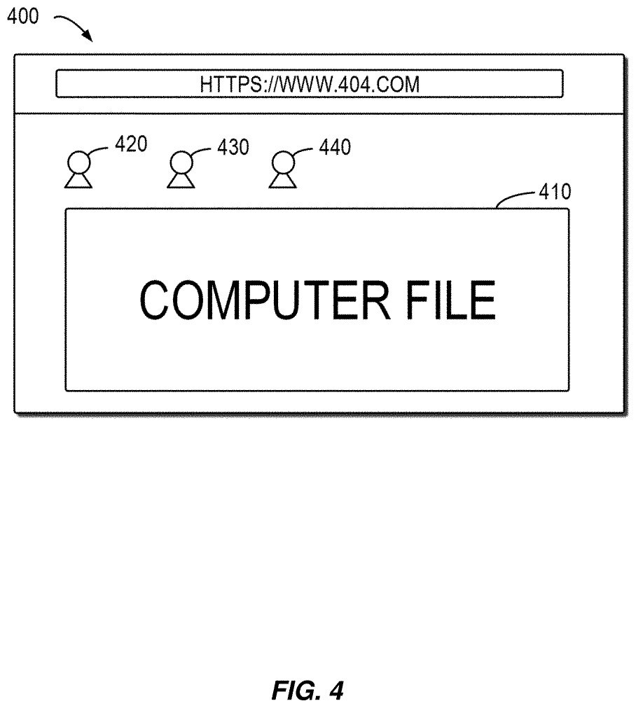

Reference is now made to FIG. 4, which shows a schematic diagram of a traditional interface 400 of a collaborative application displayed on a screen of a user. The collaborative application, such as the RTCE software, supports parallel editing by a plurality of users. The parallel editing can be enhanced by the voice input of the users. For example, in an online conversation, the collaborative application can be used with the voice meeting system which receives the voice input of the users. In this case, the users can collaboratively edit the computer file on the collaborative application, while discussing the computer file on the voice meeting system.

As shown in FIG. 4, three users 420, 430 and 440 participate in the editing of the computer file 410 in the collaborative application. Besides the parallel editing of the computer file 410, these users can discuss the computer file 410 via the voice meeting system. It is to be understood that, although FIG. 4 shows the interface 400 of a single user, such as the user 420, this interface can also be displayed on the screens of the other users, such as the users 430 and 440.

However, when the computer file under editing is too long to be displayed entirely on the screen of the user, only a part of the computer file can be displayed on the screen. The part of the computer file may be certain pages, certain texts, certain images or the like in the computer file. In this case, if a user, who is currently speaking, moves his or her focus to another part of the computer file and talks about the content of the other part, the other users may easily get confused what the currently speaking user is saying, because the other users still focus on the part previously displayed. Traditionally, it is very difficult for the other users to manually follow the exact part where the currently speaking user is focusing on. As such, user experience is significantly reduced.

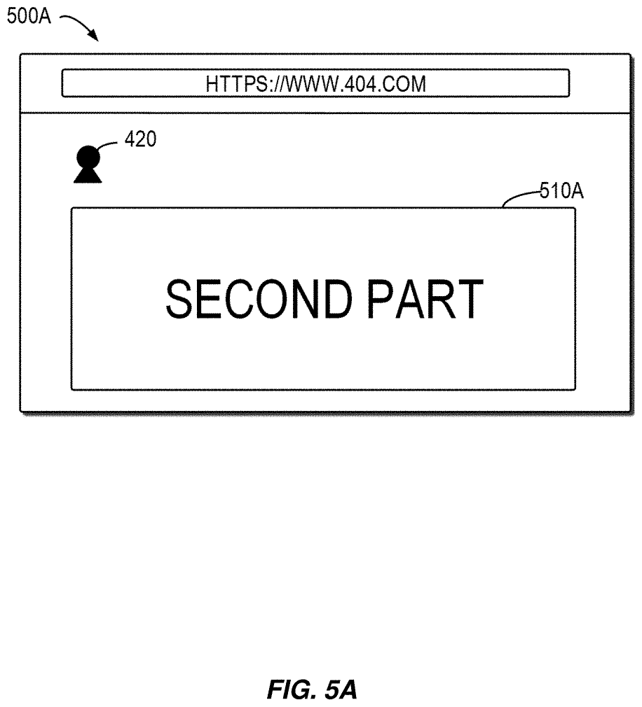

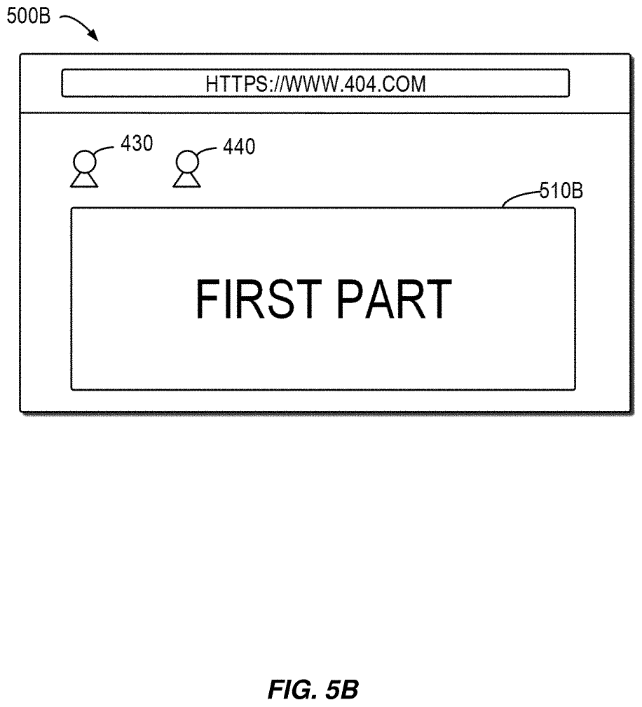

An example scenario in this case will be discussed with reference to FIGS. 5A-5B, which show example interfaces 510A and 510B, respectively. Originally, the users 420, 430 and 440 participate in the editing of the computer file in the collaborative application, and the computer file is too long to be displayed entirely on the screen of the user, such that only a part of the computer file, such as a first part, is displayed. Then, as shown in FIG. 5A, the user 420, who is currently speaking, moves his or her focus to a second part 510A of the computer file, so as to view and talk about the content of the second part 510A. However, as shown in FIG. 5B, the other users 430 and 440 still focus on the first part 510B previously displayed, in this case, the other users 430 and 440 can not follow the exact part where the user 420 is focusing on.

In order to at least partially solve one or more of the above problems and other potential problems, example embodiments of the present disclosure propose a solution for content collaboration. Voice identification information of a currently speaking user is determined based on a voice input from the currently speaking user. A focus for the currently speaking user is determined based on the voice identification information. The focus for the currently speaking user is associated with content displayed on a screen of the currently speaking user. A focus for another user is set to be the same as the focus for the currently speaking user. The focus for the other user is associated with content displayed on a screen of the other user. In this way, the content can be conveniently and efficiently collaborated, and thus the user experience is improved.

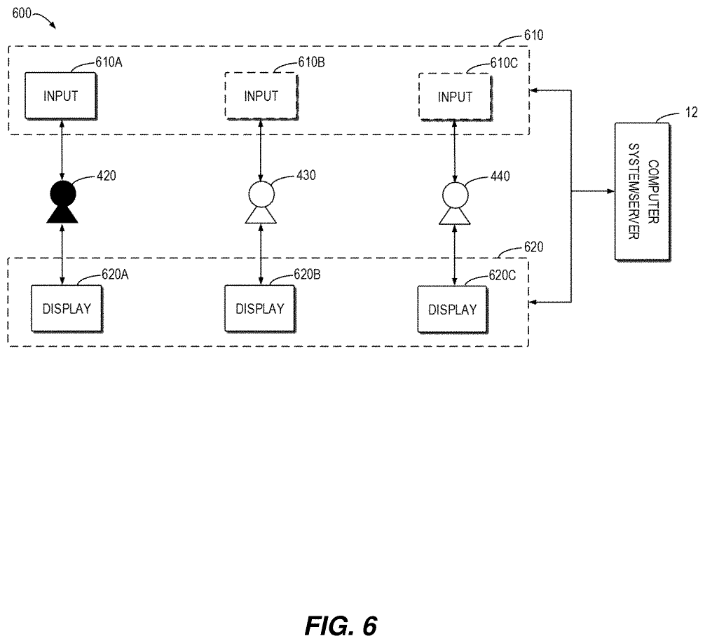

More details of embodiments for content collaboration will be discussed with reference to FIGS. 6-10. FIG. 6 shows an example content collaboration environment 600 according to an embodiment of the present invention.

As shown in FIG. 6, three users 420-440 participate in the environment 600. Each user may relate to a corresponding input and display. As shown, the users 420-440 may relate to inputs 610A-610C (collectively referred to as “input 610”) and displays 620A-620C (collectively referred to as “display 620”), respectively. The input 610 may be any suitable user input, such as the voice input, the keyboard input, the gesture input, or the like. Additionally, the display 620 can be any suitable content of a computer file displayed on the screen of the user. The computer file may be a wide variety of data, such as an image, a text, a video, a computer program or the like, and a combination thereof. The users 420, 430 and 440 are shown only for exemplary purpose. There may be any number of users that can participate in the environment 600.

Additionally, the environment 600 may include a computer system/server 12 in FIG. 1. The computer system/server 12 may assign voice identification information to a user, such that the user can be uniquely identified with respect to the input 610. The voice identification information may be an account name, a user name, a nickname, or the like. Similarly, the computer system/server 12 may assign display identification information to a user, so as to uniquely identify the user with respect to the display 620. The display identification information may be an account name, a user name, a nickname, or the like.

In the scenario shown in FIG. 6, the user 420 is currently speaking. The computer system/server 12 upon receiving the voice input from the user 420 may determine the voice identification information of the user 420 based on his or her voice input. In some embodiment, the computer system/server 12 may keep a record of the correspondence of the voice identification information and the display identification information. In this case, the computer system/server 12 may then determine the display identification information of the user 420 based on the voice identification information and the correspondence.

Then, the computer system/server 12 may determine a focus for the user 420 based on the determined display identification information. The focus is associated with the content displayed on the screen of the user 420. For example, in the scenario shown in FIG. 5A, the focus for the currently speaking user 420 is in the second part 510A of the computer file.

At this time, the computer system/server 12 may update a focus for the user 430 and a focus for the user 440 based on the focus for the user 420 for collaborating the content. In some embodiments, the computer system/server 12 may set the focus for the user 430 and the focus for the user 440 to be the same as the focus for the user 420. For example, the focus for the user 430 and the focus for the user 440 shown in FIG. 5B may be set to be the same as the focus for the user 420 shown in FIG. 5A. That is to say, the focus for the user 430 and the focus for the user 440 may be changed from the first part 510A to be in the second part 510B of the computer file.

As such, the display of the non-speaking users, such as the users 430 and 440, can be synchronized with the display of the currently speaking user, such as the user 420. In this way, the non-speaking users can know clearly where the currently speaking user is focusing on, and all the users can focus on the same content in question. Therefore, the content can be conveniently and efficiently collaborated, and thus improving the user experience.

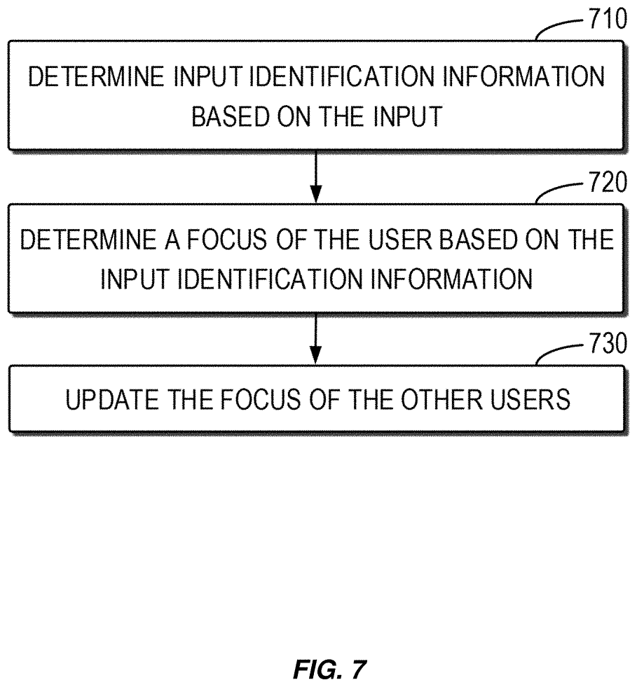

FIG. 7 shows a flow chart of an example method 700 for content collaboration according to an embodiment of the present invention. The method 700 may be at least in part implemented by the computer system/server 12, or other suitable systems.

At 710, the computer system/server 12 may determine voice identification information of a user, who is currently speaking, based on voice input of the user. In some embodiments, in determining the voice identification information, the computer system/server 12 may determine identification features from the voice input. For example, the identification feature may be used to distinguish different voices, such as pitch, sound intensity, loudness, or the like.

It should be understood that, other for the voice input, various types of input, such as a gesture input, can also be adopted. In the case of the gesture input, the identification feature may be used to distinguish different gestures, such as an angle of a movement path of a gesture made by a hand, a position of a hand, or the like.

Additionally, the computer system/server 12 may maintain a predetermined feature set. The predetermined feature set includes predetermined features associated with the users in the content collaboration environment 600, and can be used to identify the users. Likewise, the predetermined features may be used to distinguish different voices, such as pitch, sound intensity, loudness, or the like. Alternatively, the predetermined features may be used to distinguish different gestures, such as angle, position or the like. The computer system/server 12 may compare the determined identification features with the predetermined feature set. When the identification features matches the features for a certain user in the predetermined feature set, the computer system/server 12 can determine the voice identification information of that certain user.

At 720, the computer system/server 12 may determine a focus for the currently speaking user based on the voice identification information. In some embodiments, the computer system/server 12 may first determine display identification information that matches the voice identification information, and then determine the focus based on the display identification information. As described above, in some embodiment, the computer system/server 12 may keep a record of the correspondence of the voice identification information and the display identification information. Then, the computer system/server 12 may determine the display identification information of the currently speaking user based on the correspondence.

As described above, the focus is associated with the content displayed on the screen of the currently speaking user. For example, in the scenario shown in FIG. 5A, the focus for the currently speaking user 420 is in the second part 510A of the computer file. In some embodiments, if the cursor is in the content displayed on the screen of the currently speaking user, the focus can be determined based on the position of the cursor. For example, the focus can be calculated as the offset of the position of the cursor from the start of the computer file.

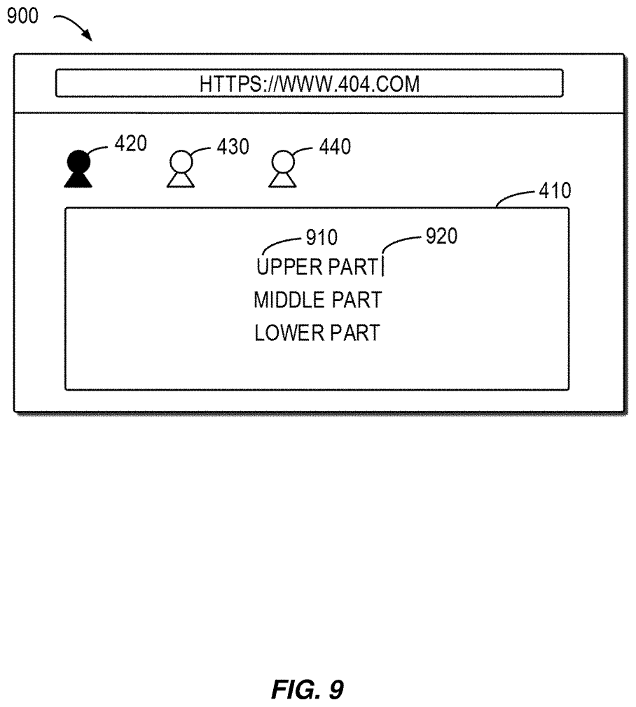

For example, as shown in FIG. 9, the start of the computer file is the character “U” 910, and the position of the character “U” 910 may be set as 1. Additionally, the cursor 920 is at the character “T”, and the position of the cursor may be set as 9, since the character “T” is the ninth character in the computer file. Thus, the offset of the cursor from the start of the computer file is 8, and thus the focus is 8.

Alternatively, if the cursor is not in the content displayed on the screen of the currently speaking user, the focus can be calculated as the offset of a reference position from the start of the computer file. For example, the reference positon can be the upper left position of the content displayed on the screen, such as the character “U” 910 as shown in FIG. 9. The reference position is not limited to the upper left position of the content, but can be any suitable position in the content, for example, the middle left position, the lower right position or the like.

At 730, the computer system/server 12 may, based on the focus for the currently speaking user, update the focus for the other users for collaborating the content. In some embodiments, the computer system/server 12 may set the focus for the other users to be the same as the focus for the currently speaking user. For example, in the scenario shown in FIG. 9, the focus for the user 430 and the focus for the user 440 may be set to be the same as the focus for the user 420. More specifically, the offset of the focus for the user 430 and the offset of the focus for the user 440 may set to be the same as the offset of the focus for the user 420. The offset may be, for example, the offset of the cursor position or the offset of the reference position. Then, the display 620 of the other users may be collaboratively updated based on the focus for the currently speaking user. As such, the users will not get confused and know clearly where the currently speaking user is focusing on.

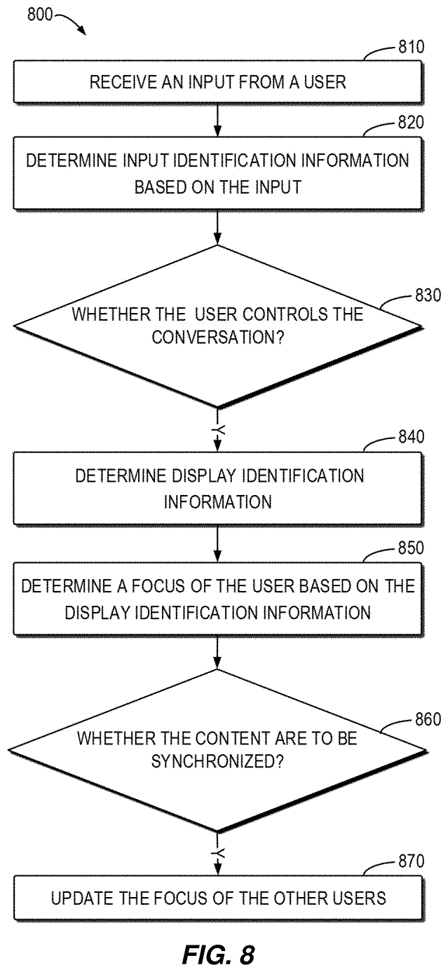

More detailed embodiments will be described with reference to FIG. 8, which shows a flow chart of an example method 800 for content collaboration according to an embodiment of the present invention. The method 800 may be at least in part implemented by the computer system/server 12, or other suitable systems.

At 810, the computer system/server 12 may receive a voice input from a user currently speaking. In some embodiments, except for the voice input, various types of input can be accepted by the computer system/server 12. For example, the input type may include a voice input, a gesture input, or the like. In this case, the computer system/server 12 may first determine an input type of the input.

Specifically, the computer system/server 12 may determine whether the input type matches a predetermined type. In some embodiments, the computer system/server 12 may allow the users of the content collaboration environment 600 to set the predetermined type of the input by an input attribute. The input attribute indicates what type of input should the computer system/server 12 use to determine the voice identification information. In some embodiments, there may be a default input attribute. In other embodiments, the users may specify their desirable input attribute. Alternatively, the users may select their desirable input attribute from a set of input attributes predetermined by the computer system/server 12. In addition, the users may view, change or remove the currently selected input attribute in computer system/server 12.

For example, a user may set the input attribute to be the voice input. In this case, when the user is currently speaking, the computer system/server 12 determines that the input type matches the predetermined type, and then the computer system/server 12 determines the voice identification information based on the voice input of the currently speaking user. In contrast, if a user is currently making a gesture, since the input type does not match the predetermined type, the computer system/server 12 will discard these inputs, and will not determine the voice identification information based on these inputs.

Then, the computer system/server 12 may determine the voice identification information of the currently speaking user based on the voice input of that user, at 820. For example, when the input type matches a predetermined type specified in the input attribute, the computer system/server 12 may determine the voice identification information of the currently speaking user based on the voice input of that user. Details in determining the voice identification information have been described above with reference to FIG. 7, thus its description is omitted here.

At 830, the computer system/server 12 may determine whether the currently speaking user controls the conversation. For example, in the case that no user is currently speaking, the user who first speaks will control the conversation. In some embodiments, the computer system/server 12 may determine a time duration of the voice input of the user. If the time duration exceeds a threshold duration, the computer system/server 12 may determine that the user controls the conversation. For example, when a certain user has already controlled the conversation, the other user need to continuously speak for a predetermined time, such as 5 seconds, so as to preempt the control of the conversation. Alternatively, the other user may wait for the certain user to stop speaking for a predetermined time, such as 10 seconds.

In some embodiments, the control of the conversation can be carried out by token management. A user who gets the token will control the conversation. The computer system/server 12 upon receiving the voice input from the user may determine whether the token is in an idle state. If the token is idle, the computer system/server 12 may allocate the token to the user and change the token state to an allocated state. Thereby, the user gets the token and controls the conversation.

If the token is not in the idle state, the computer system/server 12 may determine a time duration of the voice input of the user. If the time duration exceeds a threshold duration, the computer system/server 12 may allocate the token to the user. If the time duration does not exceed the threshold duration, the computer system/server 12 will not allocate the token to the user. In this case, the user has to wait for the token to become idle. In some embodiments, if the user who gets the token stops speaking for a predetermined time, the computer system/server 12 will release the token and change the token to the idle state.

Then, the computer system/server 12 determines display identification information that matches the voice identification information, at 840, and determines a focus for the currently speaking user based on the display identification information, at 850. Details in determining the display identification information and the focus have been described above with reference to FIG. 7, thus its description is omitted here.

At 860, the computer system/server 12 determines whether the content on the screen of the currently speaking user and the content on the screen of the other users in the content collaboration environment 600 are to be displayed synchronously. In some embodiments, the computer system/server 12 may allow the users of the content collaboration environment 600 to set a collaboration attribute. A certain user may set the collaboration attribute to indicate which of the other users can follow the certain user. In this way, the certain user can select users that he or she wishes to share the focus. For example, if the currently speaking user 420 set his or her collaboration attribute to indicate that the user 430 is allowed to follow the user 420, but the user 440 is not allowed to follow the user 420, then the focus for the user 430 will be synchronized with the user 420, but the focus for the user 440 will not be synchronized with the user 420.

Alternatively or in addition, a certain user may set the collaboration attribute to indicate which of the other users that the certain user wish to follow. In this way, the certain user can select the users with whom he or she wishes to synchronize the focus. For example, if the user 430 set his or her collaboration attribute to indicate that the user 430 wants to follow the user 420, but does not want to follow the user 440. In this case, when the user 420 is currently speaking, the focus for the user 430 will be synchronized with the user 420. However, when the user 440 is currently speaking, the focus for the user 430 will not be synchronized with the user 440.

If the computer system/server 12 determines that the content on the screen of the currently speaking user and the content on the screen of the other users in the content collaboration environment 600 are to be displayed synchronously, the computer system/server 12 may update the focus for the other users based on the focus for the currently speaking user for collaborating the content, at 870. Details in updating the focus have been described above with reference to Fig.7, thus its description is omitted here.

In this way, the focus for the plurality of users in a collaborative conversation can be automatically synchronized to be the same as the focus for the user currently speaking in the content collaboration environment, thereby the other users will not get confused and know clearly where that user is focusing on.

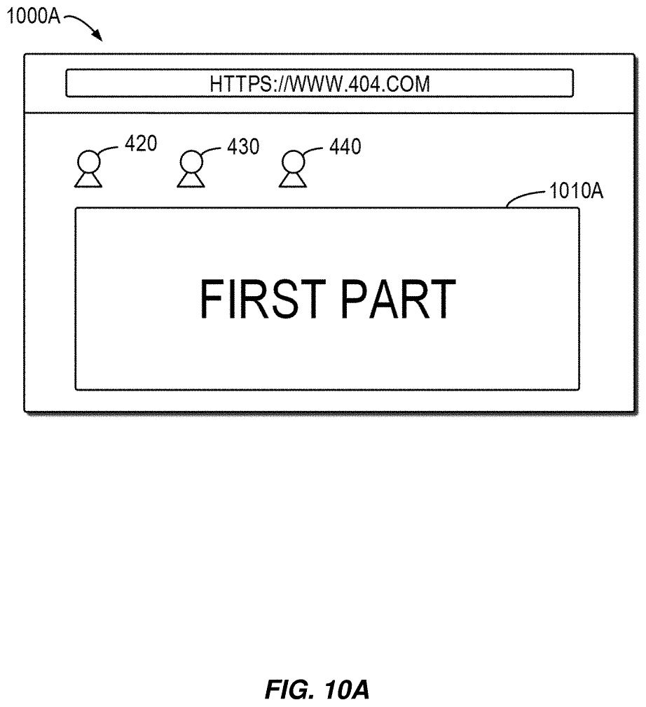

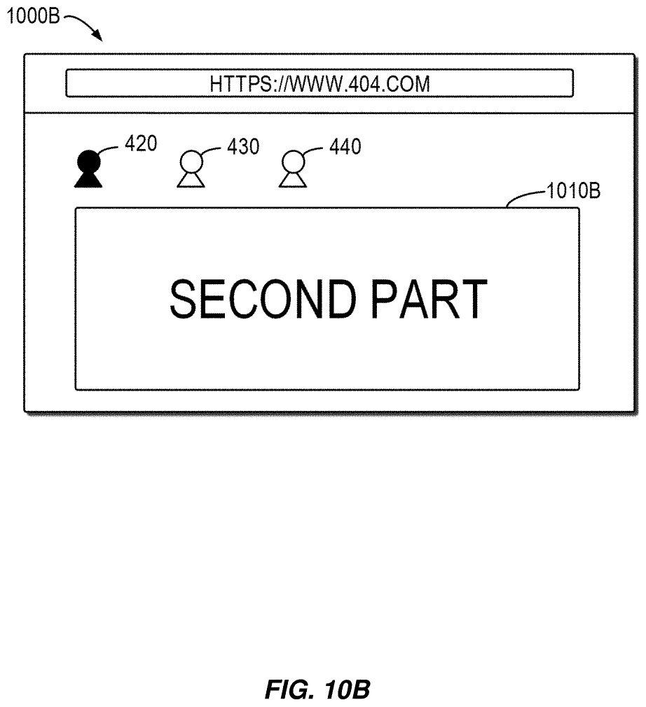

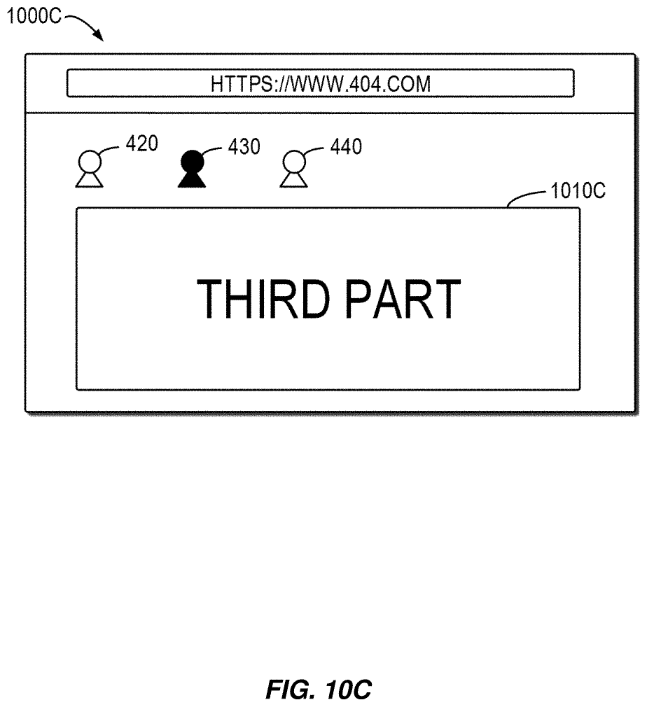

An example scenario in employing the method 800 will be described with reference to FIGS. 10A-10C. As shown in FIG. 10A, the users 420, 430 and 440 participate in the processing and discussing of the computer file. The computer file is too long to be displayed entirely on the screen of the user, such that only a part of the computer file is displayed. It is assumed that the first part 1010A of the computer file is originally displayed on the screen.

As shown in FIG. 10B, the user 420, who is currently speaking, moves his or her focus to a second part 1010B of the computer file and talks about the content of the second part 1010B. In this case, as shown in FIG. 10B, the other users 430 and 440 also change their focus to the second part 1010B as the currently speaking user 420. As such, the other users 430 and 440 can conveniently and efficiently follow the exact part where the user 420 is focusing on.

Similarly, as shown in FIG. 10C, the user 430, who is currently speaking, moves his or her focus to a third part 1010C of the computer file and talks about the content of the third part 1010C. In this case, as shown in FIG. 10C, the other users 420 and 440 also change their focus to the third part 1010C as the currently speaking user 430. As such, the other users 420 and 440 can conveniently and efficiently follow the exact part where the user 430 is focusing on. In this way, the content can be collaborated, and the user experience can be improved.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for content collaboration, comprising:
determining, by one or more computer processors, voice identification information of a first user based on a voice input from the first user;
determining, by one or more computer processors, a focus for the first user based on the voice identification information, the focus for the first user associated with first content displayed on a screen of the first user; and
setting, by one or more computer processors, a focus for a second user to be same as the focus for the first user, the focus for the second user associated with second content displayed on a screen of the second user.

2. The method of claim 1, wherein determining the voice identification information comprises:
determining an identification feature of the first user based on the voice input;
comparing the identification feature with a predetermined feature set, the predetermined feature set including predetermined features associated with a plurality of users; and
in response to the identification feature matching a predetermined feature in the predetermined feature set, determining the voice identification information based on a user associated with the predetermined feature.

3. The method of claim 1, wherein determining the focus for the first user comprises:
determining whether the first user controls a conversation; and
in response to the first user controlling the conversation, determining the focus for the first user based on the voice identification information.

4. The method of claim 3, wherein determining whether the first user controls the conversation comprises:
determining a time duration of the voice input; and
in response to the time duration exceeding a threshold duration, determining that the first user controls the conversation.

5. The method of claim 1, wherein determining the focus for the first user comprises:
determining display identification information matching the voice identification information, the display identification information associated with displaying of the first content; and
determining the focus for the first user from the first content based on the display identification information.

6. The method of claim 5, wherein determining the focus for the first user based on the display identification information comprises:
determining, based on the display identification information, a position of a cursor in the first content, the first content associated with a document viewed by the first user;
determining an offset of the position from a start of the document; and
determining the focus for the first user based on the offset.

7. The method of claim 5, wherein determining the focus for the first user based on the display identification information comprises:
determining, based on the display identification information, a reference position in the first content, the first content associated with a document viewed by the first user;
determining an offset of the reference position from a start of the document; and
determining the focus for the first user based on the offset.

8. The method of claim 1, wherein setting the focus of the second user comprises:
determining whether the first content and the second content are to be displayed synchronously; and
in response to determining that the first content and the second content are to be displayed synchronously, setting the focus of the second user to be the same as the focus for the first user.

9. A computing device for content collaboration, comprising:
a processing unit; and
a memory coupled to the processing unit and storing instructions thereon, the instructions, when executed by the processing unit, performing acts including:
determining voice identification information of a first user based on a voice input from the first user;
determining a focus for the first user for the first user based on the voice identification information, the focus for the first user associated with first content displayed on a screen of the first user; and
setting a focus for a second user to be same as the focus for the first user, the focus of the second user associated with second content displayed on a screen of the second user.

10. The computing device of claim 9, wherein determining the voice identification information comprises:
determining an identification feature of the first user based on the voice input;
comparing the identification feature with a predetermined feature set, the predetermined feature set including predetermined features associated with a plurality of users; and
in response to the identification feature matching a predetermined feature in the predetermined feature set, determining the voice identification information based on a user associated with the predetermined feature.

11. The computing device of claim 9, wherein determining the focus for the first user comprises:
determining whether the first user controls the conversation; and
in response to the first user controlling the conversation, determining the focus for the first user based on the voice identification information.

12. The computing device of claim 11, wherein determining whether the first user controls the conversation comprises:
determining a time duration of the voice input; and
in response to the time duration exceeding a threshold duration, determining that the first user controls the conversation.

13. The computing device of claim 9, wherein determining the focus for the first user comprises:
determining display identification information matching the voice identification information, the display identification information associated with displaying of the first content; and
determining the focus for the first user from the first content based on the display identification information.

14. The computing device of claim 13, wherein determining the focus for the first user based on the display identification information comprises:
determining, based on the display identification information, a position of a cursor in the first content, the first content associated with a document viewed by the first user;
determining an offset of the position from a start of the document; and
determining the focus for the first user based on the offset.

15. The computing device of claim 13, wherein determining the focus for the first user based on the display identification information comprises:
determining, based on the display identification information, a reference position in the first content, the first content associated with a document viewed by the first user;
determining an offset of the reference position from a start of the document; and
determining the focus for the first user based on the offset.

16. The computing device of claim 9, wherein setting the focus of the second user comprises:
determining whether the first content and the second content are to be displayed synchronously; and
in response to determining that the first content and the second content are to be displayed synchronously, setting the focus of the second user to be the same as the focus for the first user.

17. A computer program product being tangibly stored on a non-transient machine-readable medium and comprising machine-executable instructions, the instructions, when executed on a device, causing the device to perform acts including:
determining voice identification information of a first user based on a voice input from the first user;
determining a focus for the first user for the first user based on the voice identification information, the focus for the first user associated with first content displayed on a screen of the first user; and
setting a focus for a second user to be same as the focus for the first user, the focus of the second user associated with second content displayed on a screen of the second user.

18. The computer program product of claim 17, wherein determining the voice identification information comprises:
determining an identification feature of the first user based on the voice input;
comparing the identification feature with a predetermined feature set, the predetermined feature set including predetermined features associated with a plurality of users; and
in response to the identification feature matching a predetermined feature in the predetermined feature set, determining the voice identification information based on a user associated with the predetermined feature.

19. The computer program product of claim 17, wherein determining the focus for the first user comprises:
determining whether the first user controls the conversation; and
in response to the first user controlling the conversation, determining the focus for the first user based on the voice identification information.

20. The computer program product of claim 17, wherein determining the focus for the first user comprises:
determining display identification information matching the voice identification information, the display identification information associated with displaying of the first content; and
determining the focus for the first user from the first content based on the display identification information.
